(19) United States
(12) Patent Application Publication
(10) Pub. No.: US 2008/0122926 A1
(43) Pub. Date: May 29, 2008

(54) System and method for process segmentation using motion detection

(75) Inventors: Hanning Zhou, Seattle, WA (US); Donald Kimber, Foster City, CA (US); Althea Turner, Menlo Park, CA (US)

Correspondence Address: SUGHRUE MION, PLLC, 2100 Pennsylvania Avenue, N.W., Washington, DC, 20037, US

(73) Assignee: FUJI XEROX CO., LTD., Tokyo (JP)

(21) Appl. No.: 11/504,277

(22) Filed: Aug. 14, 2006

(51) Int. Cl. H04N 9/47; H04N 7/18

(52) U.S. Cl. 348/143; 348/159; 386/46; 348/E05.001

(57) ABSTRACT

Video recording technology is utilized to enable business process investigation in an unobtrusive manner. Several cameras are situated, each having a defined field of view. For each camera, a region of interest (ROI) within the field of view is defined, and a background image is determined for each ROI. Motion within the ROI is detected by comparing each frame to the background image. The video recording can then be segmented and indexed according to the motion detection.

### BACKGROUND

1. Field of the Invention

The subject invention relates to analysis of business processes using video cameras.

2. Related Art

Security and surveillance video cameras are well known in the art. It is also known in the art to use motion detection to activate the cameras, so that video capturing is performed only when a motion is detected in the field of view of the camera. As is known, such systems are used for security purposes, especially in places such as banks, jewelry and department stores, office buildings, etc.

Another relevant art is that of business process analysis and development. That is, occasionally in the prior art there is a need to analyze and perhaps improve on a certain business process. A business process is a set of logically related business activities that can be integrated to deliver value (products, services, etc.) to the customer. To analyze the tactical perspectives of a business process, investigators seek to understand the activities that support the process, and output a streamlined comprehensive model of how a business delivers value to the customer. The final product of such a project may comprise a set of processes and activities that take place within the organization, a text description of each process and activity, workflow diagrams, listings of inputs and outputs for each process, and key performance indicators for each process. The text description may contain detailed information about each process' purpose, triggers, timing, duration, resource requirements, etc.

The traditional manner of performing such a project is labor intensive and requires interviewing the persons involved in the business process, observing the personnel as they perform their business tasks, etc. As can be understood, such a project is highly time consuming, and much of the time can be spent while contributing little to the understanding of the business process. To illustrate, assuming that the activity investigated is the opening of a new bank account—a process that may take 10 minutes to complete. However, the investigator may have to wait a long time until a customer comes into the bank to open a new account. This waiting period does not contribute to the investigator's understanding of the process. Additionally, the presence of the investigator observing the process may cause the workers to deviate from their normal procedures, e.g., to demonstrate efficiency that normally is not utilized. Accordingly, there is a need in the art to provide a method that would enable business process investigation in an unobtrusive manner and which reduces the time required for the investigation.

### SUMMARY

According to various embodiment of the invention, video recording technology is utilized to enable business process investigation in an unobtrusive manner and which reduce the time required for the investigation.

According to various embodiment of the invention, video cameras are placed in a manner that the field of view covers the area subjected to the business process. The cameras are then operated, either in a continuous manner or during trigger of motion detection. The video recording is then analyzed to obtain meaningful information about the business process investigated. According to various embodiments, data relating to each transaction is recorded, such as, for example, the transaction's time, duration, spatial position, etc. According to other embodiments, statistical methods are applied to the data of the transaction to provide, e.g., clustering of transactions, frequency of occurrence, etc. Additionally, by applying statistical methods, outliers can be identified, such as transactions taking an abnormally long period, transactions that occur rarely or abnormally frequently, etc.

According to yet other features of the invention, screen trackers are provided. The screen trackers follow a motion detected in the field of view and, consequently, depict the motion of each moving object in the process. These motions can be plotted and analyzed. Statistical methods can be applied to the collection of motions to provide analytical information regarding the processes analyzed. According to some embodiments, the tracker is activated only when the motion is determined to be of an object beyond a threshold size and/or velocity. According to yet other embodiments, representation of the surveillance area is provided on a monitor, and a graphical representation identifies the field of view of each monitoring camera. Consequently, the screen can be set to show the entire monitored area, and the coverage of each surveillance camera overlaid on the screen.

According to further aspect of the invention, a method for analyzing process flow is provided, the process comprising determining physical areas affected by the process flow; generating a video recording using least one video camera having a field of view covering the physical area; designating at least one region of interest (ROI) in the field of view of the video recording; determining a background image in the ROI; and segmenting the video recording into process segment sessions by detecting motion in the ROI, each of the segment beginning upon detection of motion and ending upon cessation of motion.

According to yet another aspect of the invention, a method for detecting a motion in a video stream is provided, the method comprising obtaining a video stream; applying sum of absolute difference (SAD) analyses to the video stream to obtain SAD results; applying Lucas-Kanade Optical Flow (LKF) analyses to the video stream to obtain LKF results; applying Normalized Correlation (NC) analyses to the video stream to obtain NC results; and, combining the SAD results, the LKF results, and the NC results to obtain motion detection. According to another aspect, the method further comprises applying a supervised learning of a binary classifier to the SAD results, the LKF results, and the NC results.

### BRIEF DESCRIPTION OF THE DRAWINGS

Other aspects and features of the invention would be apparent from the detailed description, which is made with reference to the following drawings. It should be appreciated that the detailed description and the drawings provide various non-limiting examples of various embodiments of the invention, which is defined by the appended claims.

FIG. 1A depicts an embodiment of the invention having several cameras situated to cover a defined field of view relating to a business process to be investigated.

FIG. 1B depicts an example of trajectory plotting of detected motion.

FIG. 1C depicts an example of setting up the field of view and the ROI for one camera.

FIG. 2 depicts an example for a normalized correlation between the background image and the current image inside the ROI.

FIG. 3 depicts an example for detecting motion using the Lucas-Kanade Optical Flow method.

FIG. 4 depicts a system according to an embodiment of the invention.

FIG. 5 is a plot of the average number of customers present at each location for each half-hour increment.

FIG. 6 is a plot of the maximum number of customers present at each location for each half-hour increment.

FIG. 7 is a plot of the number of employees available to serve the customers.

FIG. 8 depicts customer-to-employee ratio for various times during the day.

FIG. 9 is a plot of the number of transactions grouped according to a transaction's duration in seconds.

FIG. 10 is a plot of entrance and exits to a service room.

### DETAILED DESCRIPTION

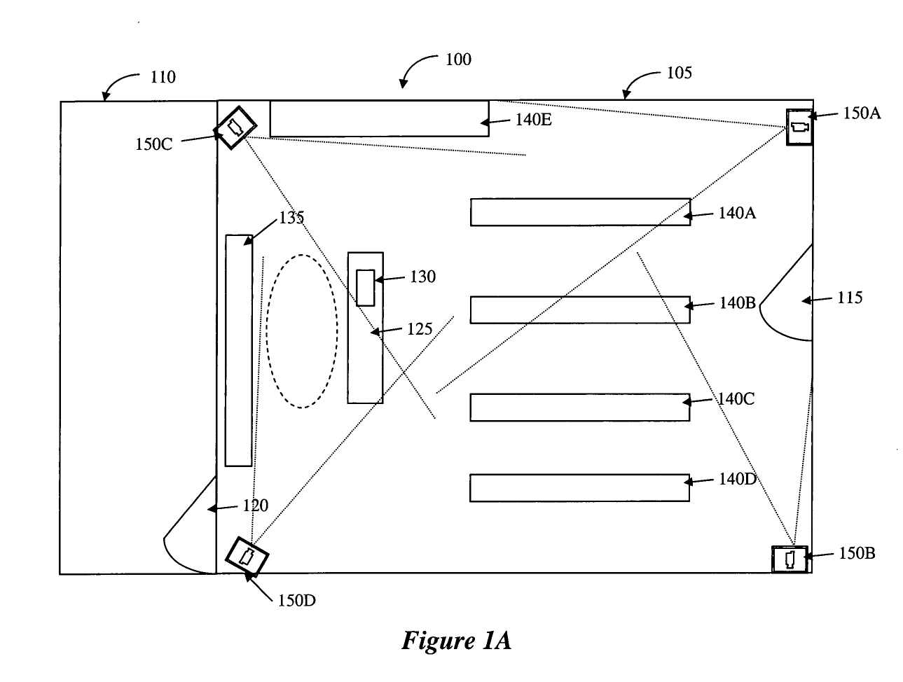

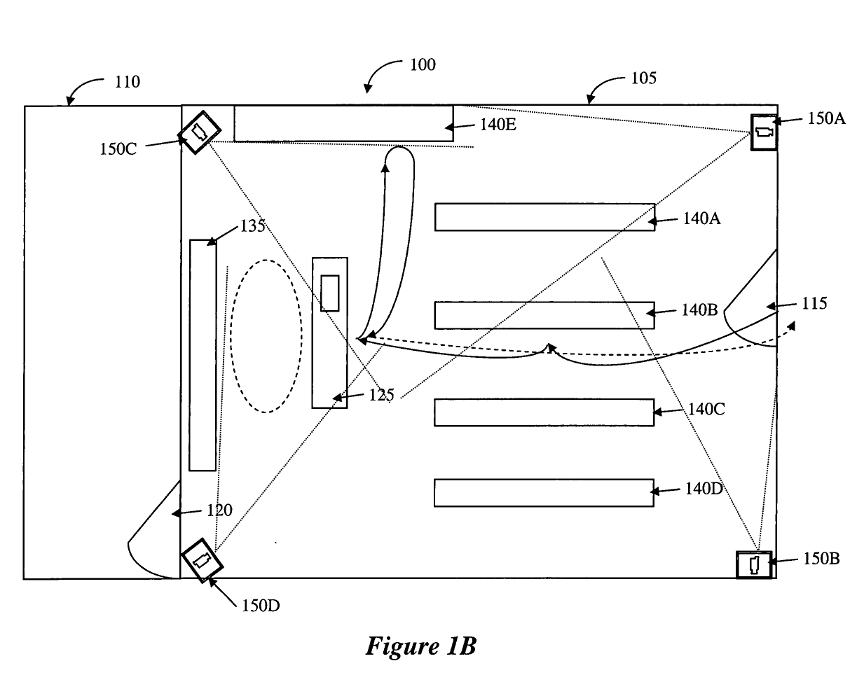

FIG. 1A depicts an embodiment of the invention having several cameras situated to cover a defined field of view relating to a business process to be investigated. The business process to be investigated takes place within enclosed area 100 having a front section 105 and a back room, such as, e.g., storage room 110. A customer entry door 115 leads into the front area 105 and an employee door 120 leads to the back room. The front room has several product shelves 140A-140E, which are open to customers' reach. Another product shelve 135 is provided behind counter 125, so that it is beyond customers' reach. The products in product shelve 135 can only be reached by an employee who is presumed to work within the area designated by the broken-line oval 155. The employee also mans the counter 125, which includes the register 130. In this example, it is desired to investigate the business processes taken place within this environment. For that purpose, it is beneficial to study the general customer behavior, e.g., which counter does the customer inspect first after entering the store, which product counter generates the most sales, which areas are most prone to neglect, how long does it takes a customer to find a desired product, etc. It is also beneficial to study the employee's actions, e.g., how long does it take the employee to serve an average customer, which type of transactions takes an unacceptably long time, etc.

To perform the study, according to this embodiment of the invention, various cameras, 150A-150D are located in various locations and each cover a defined field of view. While not shown, additional coverage can be obtain by using ceiling cameras that are aimed down to cover a floor area as a filed of view. For each camera, a region of interest (ROI) within the field of view is defined. For best results, the ROI should be chosen so that no dynamic background appears within the ROI. The background image is determined for each ROI. Then, various known methods can be used to detect motion in comparison to the background image, such as, e.g., sum of absolute difference (SAD), Lucas-Kanade Optical Flow (LKF), normalized correlation (NC), etc. That is, the motion in the ROI is detected by detecting difference in the current frame and the background frame. The motion can be tracked so as to plot the trajectory of the motion. Using the motion detection, the video can be segmented into sessions of detected motions. An index of these sessions can be generated to assist the investigator in navigating the sessions. Also, a timeline can be provided, e.g., in a graphical form on the monitor screen, to assist the investigator in navigating the sessions. One surveillance tracking algorithm that can be adapted to be used in this invention is the Reading People Tracker, which was developed by Nils T. Siebel at the University of Reading in the United Kingdom. Full description of this algorithm can be found on the university's website.

According to one embodiment, the comparison to the background frame to detection of motion is done in the red-green-blue (RGB) color space, while according to another it is performed in the hue-saturation-intensity (HIS) space. According to one embodiment, the SAD method is applied in the hue channel only so as to reduce induced noise. According to yet another embodiment, the method is modified so that a weighted sum of the difference in the hue channel is calculated. According to one embodiment the weight is correlated to the saturation value of the current pixel in the current image.

According to yet another embodiment, the noise is canceled by normalizing the signal in relation to the variation in the intensity channel. The normalized correlation (NC) method can be used for this purpose. FIG. 2 depicts an example for a normalized correlation between the background image and the current image inside the ROI, where the Y-axis is 1 minus the value of the normalized correlation, and the X-axis is the frame number. As can be understood, when the curve nears zero, it indicates that the current image is similar to the background image, meaning no motion is present. However, when the curve is high, it indicates difference between the current image and the background and, thereby indicates motion within the current image.

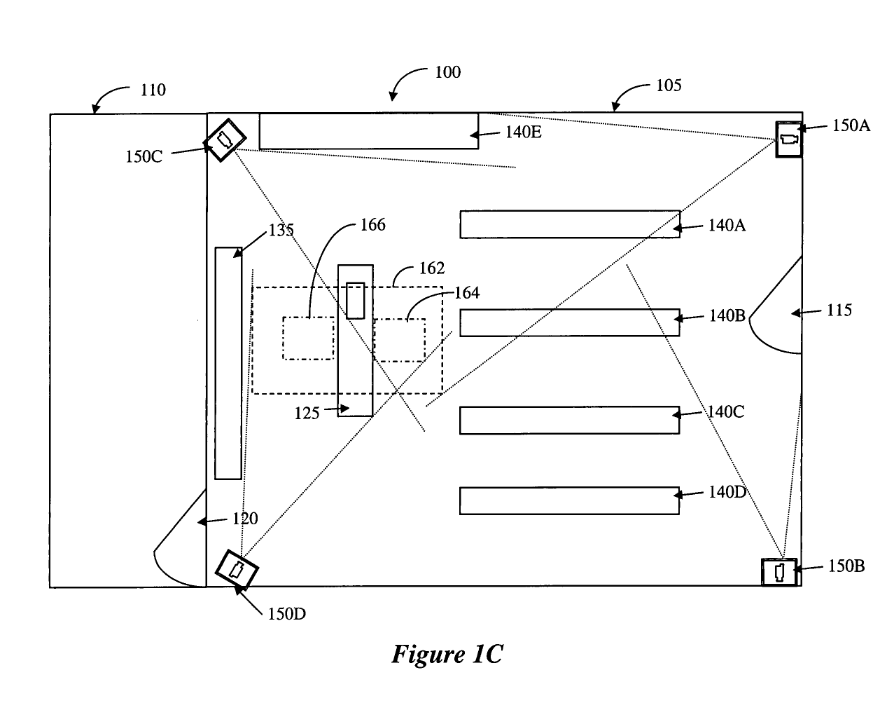

FIG. 3 depicts an example for detecting motion using the Lucas-Kanade Optical Flow method. As can be seen by comparing FIG. 2 and FIG. 3, the results given by the normalized correlation and the LKF methods do not always agree. That is, the indication of motion by either method alone is not sufficiently reliable. Therefore, an improved method is needed to allow a higher reliance on automatic detection of motion. According to one embodiment of the invention, the results of SAD, LKF and NC are combined in order to obtain an improved results. In order to determine the optimal combination of the results from these three methods, the method of supervised learning of a binary classifier has been used. Two class labels (1 and 0) are used to indicate whether there is a customer in the ROI of the subject frame.

FIG. 4 depicts a system according to an embodiment of the invention. Video cameras 410, 420 and 430 are placed at the area where the business process takes place and situated so that their field of view covers the points of interest for the business process. The cameras 410, 420 and 430 are coupled to a processor, such as a PC 460 having monitor 400. The PC 460 is programmed to control the cameras and to execute the method of the invention. Optionally, storage system 440 is connected to the PC 460 to provide a large storage area for video taken by the cameras 410, 420 and 430. Also, the PC can optionally be coupled to a server 450 for remote processing.

FIG. 1B depicts an example of trajectory plotting of detected motion. As noted above, the trajectory of the motion can be traced using motion. In this example, it is shown that a customer first approaches the middle section of product shelf 140B. The customer then proceeds to the counter 125, whereupon the customer proceeds to product shelf 140E and then returns to the counter 125. The customer then exits the front area. If such a trajectory is found to be repeated over time, it may signify that customers who are looking for a product on shelf 140E are first drawn to shelf 140B and only upon consultation with the employee proceed to find the product on shelf 140E. Thus, it is possible that shelf 140B is misleading, or that the placement of the particular product in shelf 140E is inappropriate and the product should be moved to counter 140B. In order to provide multiple traces, each motion detection can be traced using a different color on the screen, etc. Additionally, according to an embodiment of the invention, the traces are clustered according to defined parameters so as to generate clusters of motion. The parameters for the clustering can be, e.g., area of motion, frequency of motion, speed of motion, time of day of the motion, etc. Of course, several parameters can be used together to generate the clustering.

FIG. 1C depicts an example of setting up the field of view and the ROI for one camera. As shown in FIG. 1C, camera 150D has a field of view illustrated by broken-line rectangle 162. That is, the image that is shown on a monitor connected to camera 150D would consist of elements within the field of view of rectangle 162. As an example, two ROI's are illustrated by broken-dotted-line rectangles 164 and 166. When a motion is detected within ROI 164 it is understood that a customer approaches the counter. On the other hand, when a motion is detected in ROI 166 it signifies that the employee is within his post area and when no motion is detected within ROI 166 it signifies that the employee has left his post area.

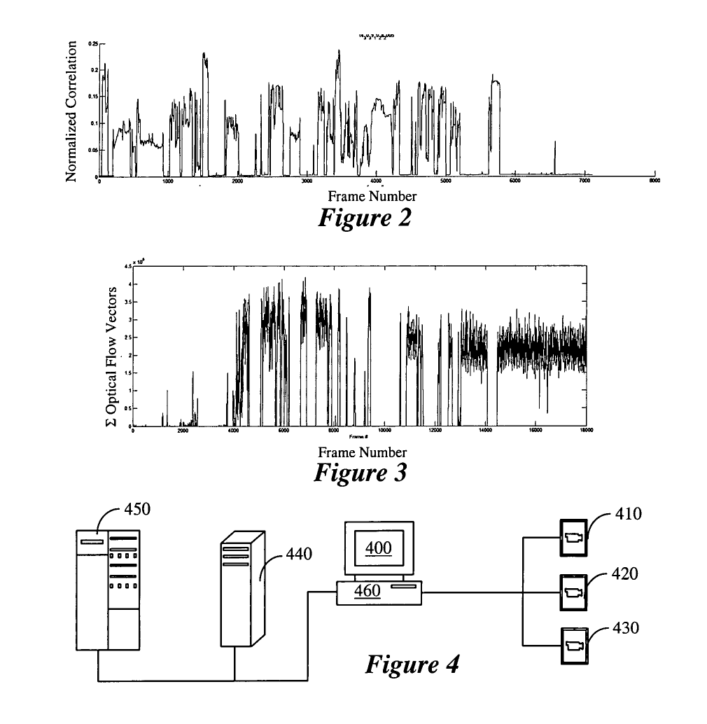

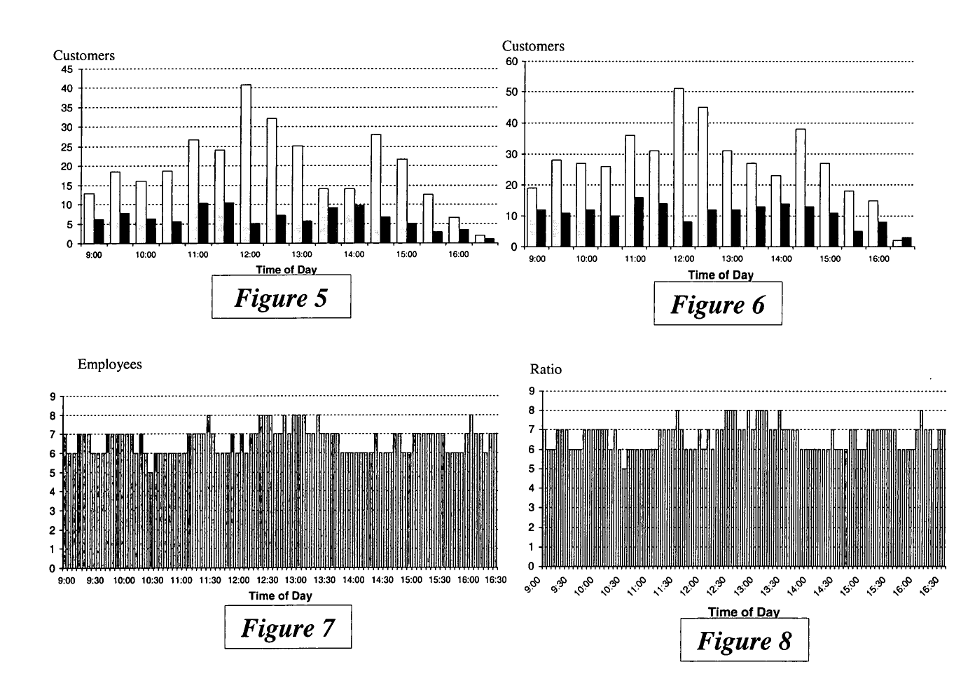

The methods and systems described herein were tested at two locations and various business methods were studied using the video captured in these two locations. For example, FIG. 5 is a plot of the average number of customers present at each location for each half-hour increment. On the other hand, FIG. 6 is a plot of the maximum number of customers present at each location for each half-hour increment. These can be obtained, e.g., by noting the number of customers (detected motion) at each ROI. FIG. 7 is a plot of the number of employees available to serve the customers. The number of customers is divided by the number of employees available to serve the customers to obtain a customer-to-employee ratio for various times during the day, as shown in FIG. 8. This provides information on customer volume and employee capacity.

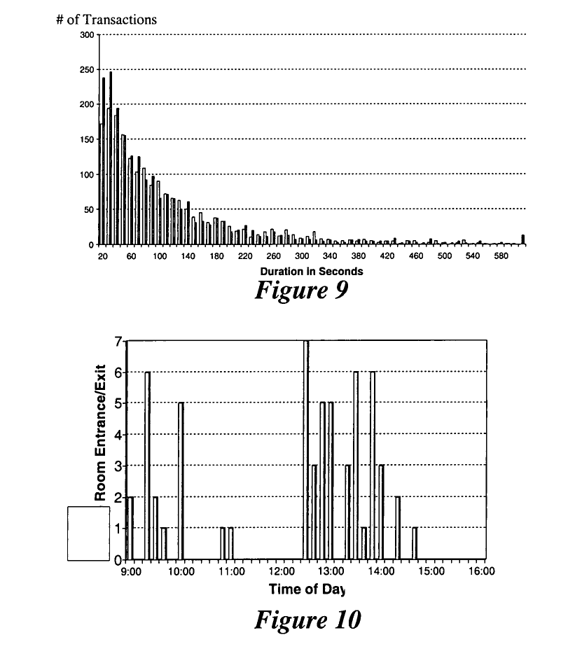

A second measure is the length of customer transaction. FIG. 9 is a plot of the number of transactions grouped according to a transaction's duration in seconds. As can be seen, the vast majority of the transactions last about a minute, and almost all of the transactions last less than 3 minutes. This can be further analyzed according to average length of stay of customers, average length of stay of customer for a transaction category (e.g., mail a letter, ship a package, purchase stamps, etc.). The transaction time can further be analyzed by analyzing wait time versus actual transaction time. That is, a ratio of transaction time to wait time can be calculated and tracked to understand potential causes of customer dissatisfaction. For example, if the ration is 0.1, it means that the customer has to wait 10 times as log as what the actual transaction takes.

Various tasks can also be analyzed for determining employee distribution. For example, FIG. 10 depicts the entrance and exits to a service room. It shows that many occur in the morning, and another grouping occurs between 12:20-2:30 pm. Thus, employee deployment can be planned accordingly. That is, additional support for the service room can be provided at these times.

The inventive method is also used to study repeat and rework issues. That is, by analyzing the video streams, it is possible to note transactions that take repeat actions to complete. Such processes can be potentially improved by consolidating actions so as to avoid repetition of actions. Similarly, inefficiency and quality improvements can be studied by analyzing processes that led to repeat reworks to correct previous errors.

Thus, while only certain embodiments of the invention have been specifically described herein, it will be apparent that numerous modifications may be made thereto without departing from the spirit and scope of the invention. Further, certain terms have been used interchangeably merely to enhance the readability of the specification and claims. It should be noted that this is not intended to lessen the generality of the terms used and they should not be construed to restrict the scope of the claims to the embodiments described therein.

1. A method for analyzing process flow, comprising:
determining physical areas affected by the process flow;
generating a video recording using least one video camera having a field of view covering said physical area;
designating at least one region of interest (ROI) in the field of view of said video recording;
determining a background image in said ROI;
segmenting said video recording into process segment sessions by detecting motion in said ROI, each of said segments beginning upon detection of motion and ending upon cessation of motion.

2. The method of claim 1, wherein said detecting motion comprises combining multiple features depicting difference between said background image and current frame.

3. The method of claim 2, wherein motions detected at multiple cameras are combined into a single event.

4. The method of claim 2, wherein a motion is detected only when said difference is above a preset threshold.

5. The method of claim 1, wherein said detecting motion comprises applying the sum of absolute difference filter to a hue channel of said video recording.

6. The method of claim 5, wherein said sum of absolute difference is weighted in correspondence with saturation value of said video recording.

7. The method of claim 1, wherein said detecting motion comprises detecting normalized correlation between the background image and a current image of said video recording.

8. The method of claim 1, further comprising indexing the segment sessions.

9. The method of claim 1, further comprising generating a trace of trajectory of each detected motion.

10. The method of claim 9, wherein said trace is generated using combined motion detected at a plurality of cameras.

11. The method of claim 9, wherein generated traces are clustered according to defined parameters.

12. The method of claim 11, wherein the parameters are selected from area of motion, frequency of motion, speed of motion, time of day of the motion.

13. The method of claim 1, wherein said detecting motion comprises combining results provided by applying sum of absolute difference (SAD), Lucas-Kanade Optical Flow (LKF), and Normalized Correlation (NC) analyses to the video recording.

14. The method of claim 13, wherein combining the results comprises applying supervised learning of a binary classifier process to the results of the SAD, LKF and NC.

15. The method of claim 1, further comprising plotting the number of customers present in said ROI per unit of time.

16. The method of claim 15, further comprising obtaining a ratio of the number of customers per employee per unit of time.

17. The method of claim 1, further comprising plotting the length of time per transaction detected in said ROI.

18. The method of claim 1, further comprising plotting the number of transactions per each length of time of transaction.

19. A system for investigating business process, comprising:
a video monitor;
a processor coupled to the monitor;
a plurality of cameras connected to said processor, each camera having a field of view;
a video driver controlled by said processor to receive video signals from said cameras and display video images on the monitor;
a user interface for defining a region of interest in an image displayed on said monitor;
a memory storing a background image defined within said region of interest;
wherein said processor detects motion in said video signals by comparing frames of said video signals to said background image.

20. The system of claim 19, wherein said processor further segments said video signals to sessions according to detected motion.

21. The system of claim 19, wherein said processor generates a trace of detected motion in said video signals.

22. The system of claim 21, wherein said processor generates the trace of detected motion by combining motions detected in video signals from a plurality of cameras.

23. The system of claim 19, wherein said processor detects motion by applying sum of absolute difference (SAD), Lucas-Kanade Optical Flow (LKF), and Normalized Correlation (NC) analyses to the video signals and combining the results obtained from the SAD, LKF and NC analysis.

24. The system of claim 23, wherein the processor combines the results by applying a supervised learning of a binary classifier process to the results of the SAD, LKF and NC.

25. A method for detecting a motion in a video stream, comprising:
obtaining a video stream;
applying sum of absolute difference (SAD) analyses to the video stream to obtain SAD results;
applying Lucas-Kanade Optical Flow (LKF) analyses to the video stream to obtain LKF results;
applying Normalized Correlation (NC) analyses to the video stream to obtain NC results; and,
combining the SAD results, the LKF results, and the NC results to obtain motion detection.

26. The method of claim 25, further comprising applying a supervised learning of a binary classifier to the SAD results, the LKF results, and the NC results.
